(19) United States
(12) Patent Application Publication
(10) Pub. No.: US 2019/0084794 A1
(43) Pub. Date: Mar. 21, 2019

(54) ELEVATOR REQUEST AUTHORIZATION SYSTEM

(71) Applicant: OTIS ELEVATOR COMPANY, Farmington, CT (US)

(72) Inventor: Bradley Armand Scoville, Farmington, CT (US)

(21) Appl. No.: 15/710,258

(22) Filed: Sep. 20, 2017

(51) Int. Cl. B66B 1/34; B66B 3/00; B66B 1/46

(52) U.S. Cl. CPC B66B 1/3453; B66B 3/006; G07C 2209/62; B66B 2201/4676; B66B 2201/4615; B66B 1/468

(57) ABSTRACT

An elevator request authorization system for use in a building in which an elevator system services a plurality of floors is provided. The elevator request authorization system includes one or more servers receptive of an elevator request of a user and configured to authenticate the elevator request and to append credential data thereto in accordance with a result of the authentication and an access control system to which the elevator request appended with the credential data is passed from the one or more servers. The access control system is configured to determine which floors of the plurality of floors the user is authorized to visit based on the credential data with an elevator car being assignable to service the elevator request in accordance with a determination result.

### BACKGROUND

The following description relates to elevator systems and, more specifically, to a mobile elevator request floor authorization system of an elevator system.

In the fields of physical security and information security, access control (AC) is the selective restriction of access to a place or other resource. The act of accessing may mean consuming, entering or using. Permission to access a resource is called authorization.

In a building, AC is employed to permit or prevent access to certain areas or floors by various personnel. For example, in a hotel, hotel guests may be permitted to have access to their guestrooms and public areas but not to other guestrooms or hotel offices. On the other hand, cleaning services may have access to all the guestrooms.

In any case, movement between floors in a building is often provided by way of an elevator system that is responsive to elevator requests made in elevator bays. Those elevator requests may be improper, however, as in a case in which a hotel guest or cleaning person requests travel to a floor in the hotel to which he does not have access.

### BRIEF DESCRIPTION

According to an aspect of the disclosure, elevator request authorization system for use in a building in which an elevator system services a plurality of floors is provided. The elevator request authorization system includes one or more servers receptive of an elevator request of a user and configured to authenticate the elevator request and to append credential data thereto in accordance with a result of the authentication and an access control system to which the elevator request appended with the credential data is passed from the one or more servers. The access control system is configured to determine which floors of the plurality of floors the user is authorized to visit based on the credential data with an elevator car being assignable to service the elevator request in accordance with a determination result.

In accordance with additional or alternative embodiments, the elevator request authorization system further includes a mobile computing device by which the user instantiates the elevator request.

In accordance with additional or alternative embodiments, the mobile computing device includes a registered smartphone on which an elevator request application is installed.

In accordance with additional or alternative embodiments, the access control system is configured to determine which floors of the plurality of floors a user generating an elevator request with secure identification is authorized to visit.

In accordance with additional or alternative embodiments, the user is registered with at least one of the one or more servers.

In accordance with additional or alternative embodiments, one or more elevator cars are respectively dispatchable to one or more floors of the plurality of floors and a dispatcher unit is configured to dispatch the one or more elevator cars to the one or more floors of the plurality of floors.

In accordance with additional or alternative embodiments, the access control system further includes one or more additional servers to determine which floors of the plurality of floors the user is authorized to visit based on the credential data and to direct a call signal toward and to receive a car assignment signal from the dispatcher unit.

According to another aspect of the disclosure, an elevator system of a building is provided. The elevator system includes elevator cars servicing a plurality of floors of the building and a dispatcher unit configured to dispatch the elevator cars in response to elevator requests. The elevator system is included in an elevator request authorization system which is deployed in the building and includes one or more servers receptive of an elevator request of a user and configured to authenticate the elevator request and to append credential data thereto in accordance with a result of the authentication and an access control system to which the elevator request appended with the credential data is passed from the one or more servers. The access control system is configured to determine which floors of the plurality of floors the user is authorized to visit based on the credential data with one of the elevator cars being assignable via the dispatcher unit to service the elevator request in accordance with a determination result.

In accordance with additional or alternative embodiments, the elevator request authorization system further includes a mobile computing device by which the user instantiates the elevator request.

In accordance with additional or alternative embodiments, the mobile computing device includes a registered smartphone on which an elevator request application is installed.

In accordance with additional or alternative embodiments, the access control system is configured to determine which floors of the plurality of floors a user generating an elevator request with secure identification is authorized to visit.

In accordance with additional or alternative embodiments, the user is registered with at least one of the one or more servers.

In accordance with additional or alternative embodiments, one or more elevator cars are respectively dispatchable to one or more floors of the plurality of floors and a dispatcher unit is configured to dispatch the one or more elevator cars to the one or more floors of the plurality of floors.

In accordance with additional or alternative embodiments, the access control system further includes one or more additional servers to determine which floors of the plurality of floors the user is authorized to visit based on the credential data and to direct a call signal toward and to receive a car assignment signal from the dispatcher unit.

According to yet another aspect of the disclosure, a method of executing elevator request authorization is provided for use with an elevator system servicing a plurality of floors of a building. The method includes receiving an elevator request of a user, authenticating the elevator request, appending credential data to the elevator request in accordance with a result of the authentication, passing the elevator request appended with the credential data to an access control system and determining, at the access control system, which floors of the plurality of floors the user is authorized to visit based on the credential data with an elevator car being assignable to service the elevator request in accordance with a determination result.

In accordance with additional or alternative embodiments, the elevator request is instantiated by the user with a mobile computing device.

In accordance with additional or alternative embodiments, the mobile computing device includes a registered smartphone on which an elevator request application is installed.

In accordance with additional or alternative embodiments, the method further includes receiving, at the access control system, an additional elevator request associated with secure identification and determining, at the access control system, which floors of the plurality of floors a user generating the additional elevator request with the secure identification is authorized to visit.

In accordance with additional or alternative embodiments, the method further includes registering the user.

In accordance with additional or alternative embodiments, the determining, at the access control system, which floors of the plurality of floors the user is authorized to visit based on the credential data includes generating a signal that is receivable by the fourth server in accordance with a result of the determining.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a schematic illustration of a building in accordance with embodiments;

FIG. 2 is a schematic diagram illustrating an elevator request authorization system of the building of FIG. 1 in accordance with embodiments; and

FIG. 3 is a schematic diagram of a computing device of the elevator request authorization system of FIG. 2 in accordance with embodiments.

### DETAILED DESCRIPTION

As will be described below, an elevator request authorization system is provided to provide smartphone users the ability to call an elevator from their smartphone. To provide security authorization functionality for smartphone users, the elevator request authorization system routes the same credential data to a security system whether the user makes an elevator request from their smartphone or by way of a radio frequency identification (RFID) card or any other known security credentialing method. That is, a smartphone user registers with a remote or first server and completes a user account setup with the same credential data that would otherwise be used in the RFID card or secure identification cases and which is programmed in an access control system (i.e., when a smartphone user registers, a building manager or security personnel for the building approves the user registration and inputs credential information for the user that is the same as what is present in the access control database). Following registration, the smartphone user makes an elevator request on their smartphone which is transmitted to the remote or first server. The elevator request is authenticated by the remote or first server and the corresponding credential data is appended to the elevator request. The elevator request and the appended credential data is then routed to a local or second server and passed to the access control system. Within the access control system, the user's authorized floors are verified based on the credential data. An elevator car assignment can then be made with an elevator car dispatched thereafter.

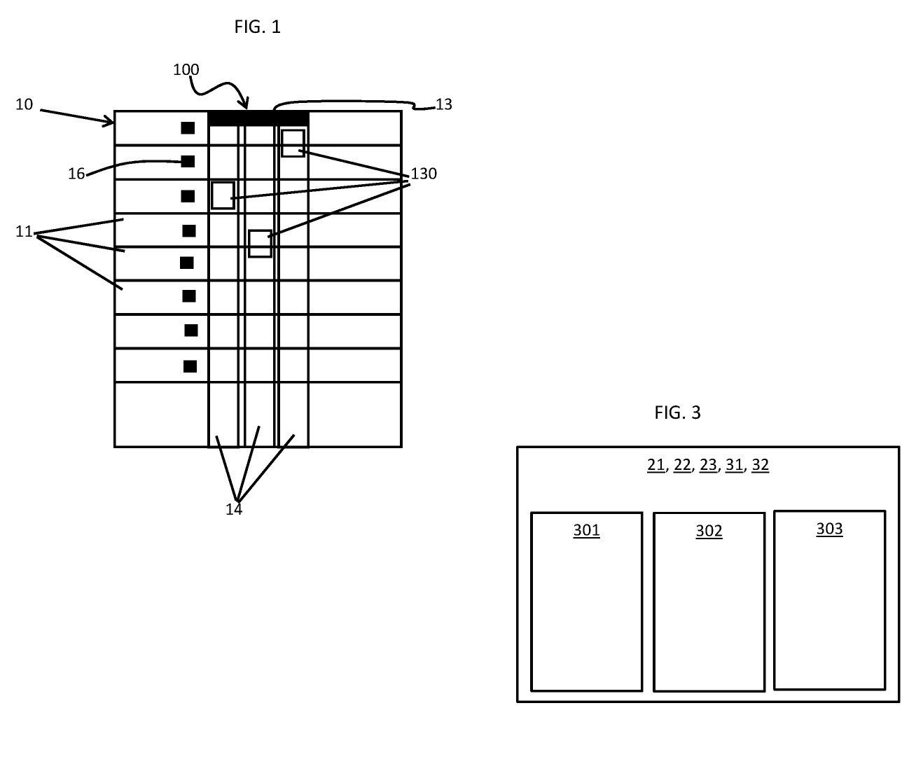

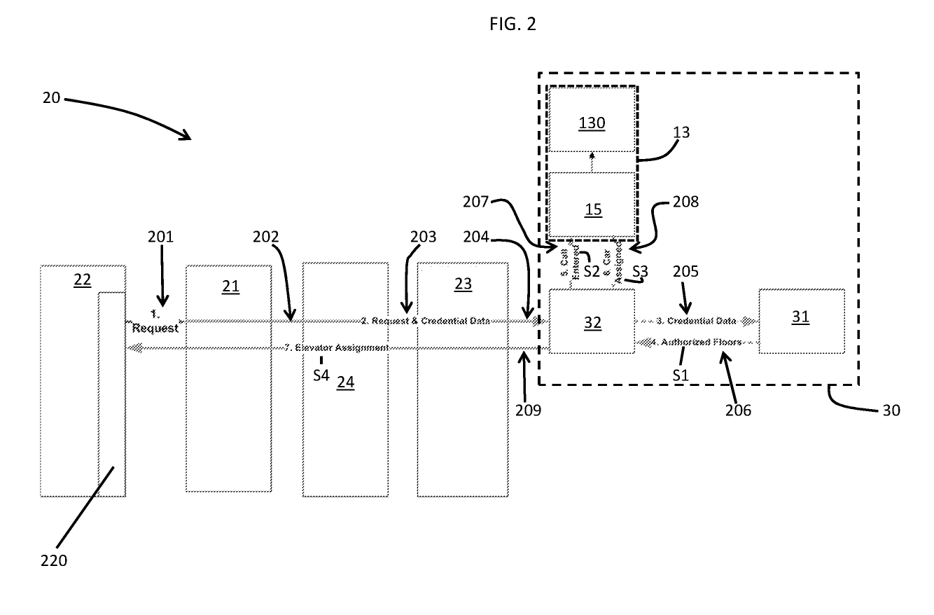

With reference to FIG. 1, a building 10 is provided. The building 10 may be a hotel, an office building, an apartment building or any other type of building and includes a plurality of floors 11 and an access control system 100. The access control system 100 is generally configured to prevent or permit access to areas in the building 10 and includes or, more commonly, communicates with an elevator system 13. The elevator system 13 includes one or more elevator cars 130 that travel through hoistways 14 to service the plurality of the floors 11 and a dispatcher unit 15 (FIG. 2). The dispatcher unit 15 is configured to dispatch the one or more elevator cars 130 in response to elevator requests. The elevator requests may be generated at each of the plurality of floors 11 by users placing an RFID card or some other form of security identification in front of readers 16 that are distributed throughout the building 10 or by way of portable computing devices as will be described below and then entering an elevator request into a keyboard, keypad or kiosk associated with the nearby reader 16.

With continued reference to FIG. 1 and with additional reference to FIG. 2, the elevator system 13 further includes an elevator request authorization system 20 that determines which floors a user is authorized to visit and dispatches the one or more elevator cars 130 based on results of that determination. The elevator request authorization system 20 includes a remote or first server (hereinafter referred to as a “first server”) 21, which may be but is not required to be remote from the building 10 and which is accessible by a portable computing device 22 of the user, a local or second server (hereinafter referred to as a “second server”) 23 which may be but is not required to be disposed locally relative to the building 10, an internet gateway 24 and components 30 of the access control system 100. The internet gateway 24 is electrically and communicatively interposed between the first server 21 and the second server 23.

The portable computing device 22 of the user may be provided as a smartphone, a smart watch, a tablet, a laptop computer, etc. In any case, the portable computing device 22 may have an application 220, such as an elevator request application, stored thereon for facilitating an interface between the user and the elevator system 13 of the building 10. The user initially uses the application 220 to register himself and the portable computing device 22 with the first server 21 or, in alternative embodiments, with other computing devices such as the second server 23 or with some of the components 30 of the access control system 100. For purposes of clarity and brevity, the following description will relate to the case of the portable computing device 22 being a smartphone.

The first server 21 is receptive of an elevator request of a user. The elevator request may be made and instantiated by the user through the application 220 of the portable computing device 22. Upon such reception of the elevator request by the first server 21, the first server 21 is configured to authenticate the elevator request and to append credential data thereto in accordance with a result of the authentication. The credential data is associated with access rights of the user and is established upon completion of the registration.

The second server 23 is receptive of the elevator request appended with the credential data from the first server 21 via the internet gateway 24 and passes the elevator request appended with the credential data to the components 30 of the access control system 100.

In accordance with embodiments, the components 30 of the access control system 100 receive the elevator request appended with the credential data from the second server 23 and are configured to analyze the credential data, to determine which floors of the plurality of floors 11 of the building 10 the user is authorized to visit based on the credential data and to assign an elevator car 130 to service the elevator request in accordance with a result of the determination. The components 30 of the access control system 100 are further configured to determine, using similar inputs and algorithms, which floors of the plurality of floors 11 a user generating an elevator request with an RFID card or some other form of security identification is authorized to visit.

In accordance with alternative embodiments, other computing devices described herein may be disposed and configured to complete all or a portion of the operations of the components 30 of the access control system 100. For example, either the first server 21 or the second server 23 may be disposed and configured to analyze the credential data, to determine which floors of the plurality of floors 11 of the building 10 the user is authorized to visit based on the credential data, to assign an elevator car 130 to service the elevator request in accordance with a result of the determination and to determine, using similar inputs and algorithms, which floors of the plurality of floors 11 a user generating an elevator request with an RFID card or some other form of security identification is authorized to visit.

As shown in FIG. 2, the components 30 of the access control system 100 include the one or more elevator cars 130 and the dispatcher unit 15 as well as a physical access control or third server (hereinafter referred to as a “third server”) 31 and an additional or fourth server (hereinafter referred to as a “fourth server”) 32. The third and fourth servers 31 and 32 may be disposed remotely or locally with respect to the building 10 and, in some cases, may be provided as cloud computing servers or the like.

In accordance with embodiments, the third server 31 is configured to be receptive of the credential data, to analyze the credential data, to determine which floors of the plurality of floors 11 the user is authorized to visit based on results of the analysis of the credential data and to generate a signal S1 accordingly. This signal S1 is indicative or reflective of those floors of the plurality of floors 11 the user is authorized to access. The fourth server 32 is configured to receive the elevator request appended with the credential data from the second server 23, to direct the credential data toward and to receive the signal S1 from the third server 31.

In an event the signal S1 is inconsistent with the elevator request (i.e., the elevator request would take the user to a floor he is not authorized to access), the fourth server 32 may refuse to act on the elevator request and may issue a refuse notification to the application 220 whereby the user can be advised of the refusal.

In an event the signal S1 is consistent with the elevator request (i.e., the elevator request takes the user to a floor he is authorized to access), the fourth server 32 directs a call signal S2, which is consistent with the elevator request, toward the dispatcher unit 15. The dispatcher unit 15 then dispatches an elevator car 130 to service the elevator request and issues a car assignment signal S3 to the fourth server 32. The fourth server 32 is further configured to be receptive of the car assignment signal S3 and to issue an elevator assignment signal S4 to the application 220 whereby the user may be advised that an elevator car 130 is about to be or has been dispatched to service the elevator request.

With reference to FIG. 3, each computing device described herein (e.g., the portable computing device 22, the first server 21, the second server 23, the third server 31 and the fourth server 32) may be provided as a standalone element or an element that is provided in combination with another. For example, the first and second servers 21 and 23 may be provided as one or more servers and the third and fourth servers 31 and 32 may be provided as one or more additional servers. In any case, each computing device described herein may generally include a central processing unit 301, a memory unit 302 and a networking unit 303 by which the central processing unit 301 of each computing device communicates with other computing devices. The memory unit 302 has executable instructions stored thereon and which are executable by the central processing unit 301 to execute various methods, processes and algorithms. At least some of these method, processes and algorithms are described above and below.

With reference back to FIG. 2, a method of executing elevator request authorization for use with elevator system 13 servicing the plurality of floors 11 of the building 10 is provided. In accordance with embodiments, the method may include generating an elevator request of a user with the application 220 of the mobile computing device 22 (201), receiving and authenticating the elevator request and subsequently appending the credential data in accordance with a result of the authentication to the elevator request at the first server 21 (202), receiving the elevator request appended with the credential data from the first server 21 at the third server 23 by way of internet gateway 24 (203) and passing the elevator request appended with the credential data from the second server 23 to the fourth server 32 of the components 30 of the access control system 100 (204).

In accordance with further embodiments, the method may also include directing the credential data from the fourth server 32 to the third server 31 (205), analyzing the credential data, determining from a result of the analysis which floors of the plurality of floors 11 the user is authorized to visit based on the credential data at the third server 31 and issuing the signal S1 back to the fourth server 32 (206). At this point, in an event the signal S1 is consistent with the elevator request (i.e., the elevator request takes the user to a floor he is authorized to access), the method may also include directing a call signal S2, which is consistent with the elevator request, from the fourth server 32 toward the dispatcher unit 15 (207), dispatching an elevator car 130 to service the elevator request and issuing car assignment signal S3 to the fourth server 32 at and from the dispatcher unit 15 (208) and, upon reception of the car assignment signal S3 at the fourth server 32, issuing the elevator assignment signal S4 from the fourth server 32 to the application 220 (209).

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. An elevator request authorization system for use in a building in which an elevator system services a plurality of floors, the elevator request authorization system comprising:
one or more servers receptive of an elevator request of a user and configured to authenticate the elevator request and to append credential data thereto in accordance with a result of the authentication; and
an access control system to which the elevator request appended with the credential data is passed from the one or more servers,
the access control system being configured to determine which floors of the plurality of floors the user is authorized to visit based on the credential data with an elevator car being assignable to service the elevator request in accordance with a determination result.

2. The elevator request authorization system according to claim 1, further comprising a mobile computing device by which the user instantiates the elevator request.

3. The elevator request authorization system according to claim 2, wherein the mobile computing device comprises a registered smartphone on which an elevator request application is installed.

4. The elevator request authorization system according to claim 1, wherein the access control system is configured to determine which floors of the plurality of floors a user generating an elevator request with secure identification is authorized to visit.

5. The elevator request authorization system according to claim 1, wherein the user is registered with at least one of the one or more servers.

6. The elevator request authorization system according to claim 1, wherein:
one or more elevator cars are respectively dispatchable to one or more floors of the plurality of floors; and
a dispatcher unit is configured to dispatch the one or more elevator cars to the one or more floors of the plurality of floors.

7. The elevator request authorization system according to claim 6, wherein the access control system further comprises one or more additional servers to determine which floors of the plurality of floors the user is authorized to visit based on the credential data and to direct a call signal toward and to receive a car assignment signal from the dispatcher unit.

8. An elevator system of a building, comprising:
elevator cars servicing a plurality of floors of the building; and
a dispatcher unit configured to dispatch the elevator cars in response to elevator requests,
the elevator system being included in an elevator request authorization system which is deployed in the building and comprises:
one or more servers receptive of an elevator request of a user and configured to authenticate the elevator request and to append credential data thereto in accordance with a result of the authentication; and
an access control system to which the elevator request appended with the credential data is passed from the one or more servers,
the access control system being configured to determine which floors of the plurality of floors the user is authorized to visit based on the credential data with one of the elevator cars being assignable via the dispatcher unit to service the elevator request in accordance with a determination result.

9. The elevator system according to claim 8, further comprising a mobile computing device by which the user instantiates the elevator request.

10. The elevator system according to claim 9, wherein the mobile computing device comprises a registered smartphone on which an elevator request application is installed.

11. The elevator system according to claim 8, wherein the access control system is configured to determine which floors of the plurality of floors a user generating an elevator request with secure identification is authorized to visit.

12. The elevator system according to claim 8, wherein the user is registered with at least one of the one or more servers.

13. The elevator system according to claim 8, wherein the access control system comprises the elevator cars and the dispatcher unit.

14. The elevator system according to claim 13, wherein the access control system further comprises one or more additional servers configured to determine which floors of the plurality of floors the user is authorized to visit based on the credential data and to direct a call signal toward and to receive a car assignment signal from the dispatcher unit.

15. A method of executing elevator request authorization for use with an elevator system servicing a plurality of floors of a building, the method comprising:
receiving an elevator request of a user;
authenticating the elevator request;
appending credential data to the elevator request in accordance with a result of the authentication;
passing the elevator request appended with the credential data to an access control system; and
determining, at the access control system, which floors of the plurality of floors the user is authorized to visit based on the credential data with an elevator car being assignable to service the elevator request in accordance with a determination result.

16. The method according to claim 15, wherein the elevator request is instantiated by the user with a mobile computing device.

17. The method according to claim 16, wherein the mobile computing device comprises a registered smartphone on which an elevator request application is installed.

18. The method according to claim 15, further comprising:
receiving, at the access control system, an additional elevator request associated with secure identification; and
determining, at the access control system, which floors of the plurality of floors a user generating the additional elevator request with the secure identification is authorized to visit.

19. The method according to claim 15, further comprising registering the user.

20. The method according to claim 15, wherein the determining, at the access control system, which floors of the plurality of floors the user is authorized to visit based on the credential data comprises generating a signal in accordance with a result of the determining.
